(19) United States
(12) Patent Application Publication
(10) Pub. No.: US 2007/0171039 A1
(43) Pub. Date: Jul. 26, 2007

(54) Indication device for vehicles

(76) Inventor: Ching-Ho Yang, Dajia Township (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/337,702

(22) Filed: Jan. 23, 2006

(51) Int. Cl. B60Q 1/54

(52) U.S. Cl. 340/466

(57) ABSTRACT

An indication device for vehicles is installed to an obvious position of the vehicle such as at rear of the vehicle and includes a first section, a second section and a third section. The indication device is controlled by a controller and each section includes an indication member, such as an arrow which lights up to represent specific information. The three indication members represent three specific information of the speed of the vehicle such as the speed is increased, reduced and below a pre-set value.

### FIELD OF THE INVENTION

The present invention relates to an indication device connected to a rear end of vehicles and indicating different status of the vehicle so that the following vehicles acknowledge the situation of the vehicle in front.

### BACKGROUND OF THE INVENTION

A rear end of a conventional vehicle 10 is shown in FIG. 1 and generally includes two taillights 12, two turn signals 11 and a brake light 13. The turn signals light up when the driver operates the control lever before turning so that the drivers in the following vehicles know that the vehicle in front of him is going to slow down and turns. The brake light 13 lights up when the brake pad is pushed by the driver so as to send a message to the drivers of the following vehicles that the vehicle reduces its speed. All of the turn signals 11 and the brake light 13 provide important information of the operation of the vehicle such that the related drivers or even the pedestrians can response accordingly.

When in emergency situation, the driver pushes an emergency button so that both of the two turn signals 11 are flashing. However, no turning signals can be sent to the drivers of the following vehicles so that the drivers of the following vehicles might make wrong judgments to the vehicle with flashing turn signals and accidents might happen. Besides, when the vehicle in front is a big one and blocks the sight of the drivers of the following vehicles, only the brake light cannot provide sufficient information to the drivers of the following vehicles. Therefore, the drivers of the following vehicles might not able to response in some situations.

The present invention intends to provide an indication device which provides the speed situations of the vehicle so that the drivers of the following vehicles can response correctly according to the signals illustrated from the indication device.

### SUMMARY OF THE INVENTION

The present invention relates to an indication device for vehicles and the indication device comprises a first section, a second section and a third section. The indication device is controlled by a controller and each section has an indication member which lights up to represent specific information of speed of the vehicle.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a rear view of a vehicle which includes conventional brake light, taillights and turn signals;

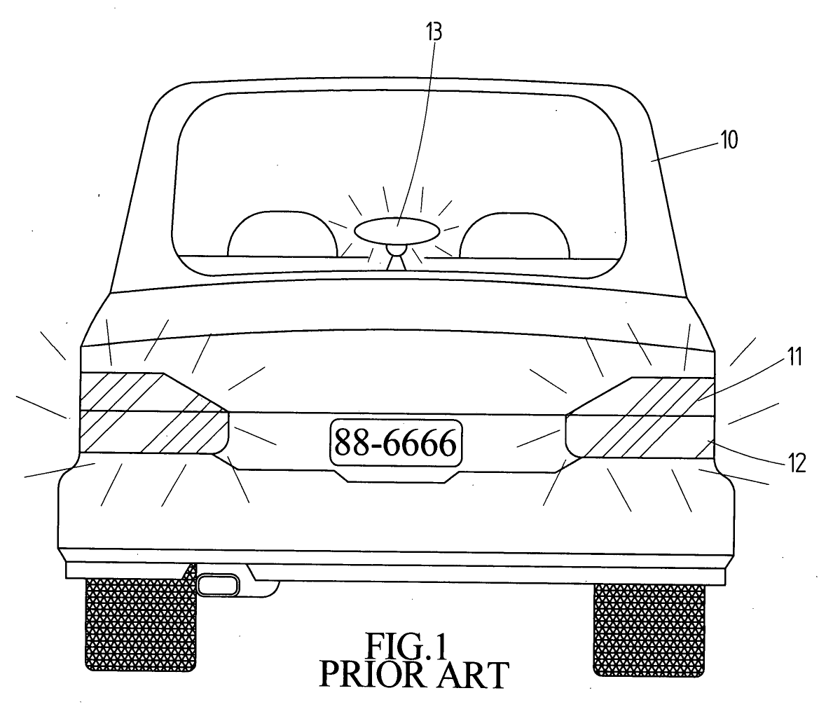

FIG. 2 shows the indication device of the present invention;

FIG. 3 shows that the indication device of the present invention is connected to a rear end of a vehicle, wherein the first section lights up;

FIG. 4 shows that the indication device of the present invention is connected to a rear end of a vehicle, wherein the second section lights up, and

FIG. 5 shows that the indication device of the present invention is connected to a rear end of a vehicle, wherein the third section lights up.

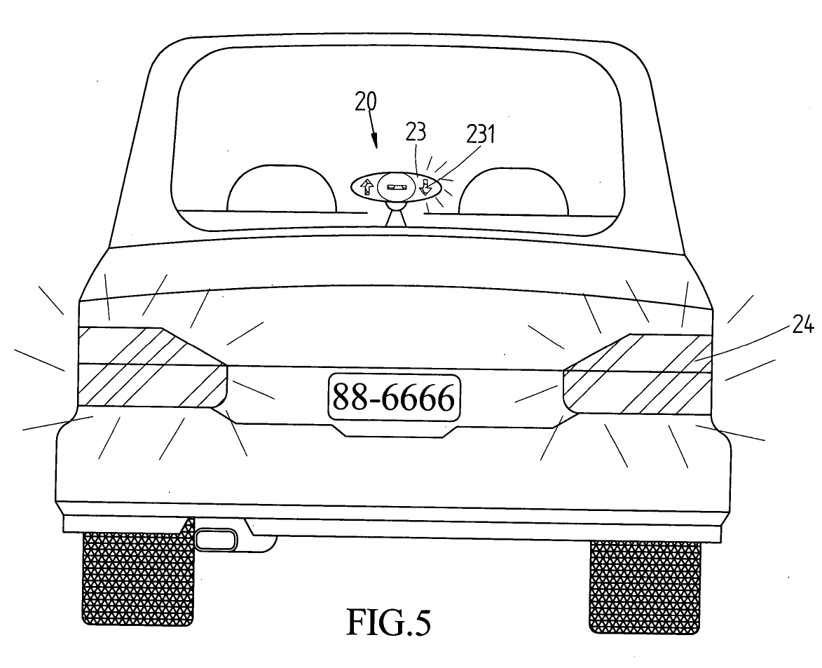

### DETAILED DESCRIPTION OF THE PREFERRED EMBODIMENT

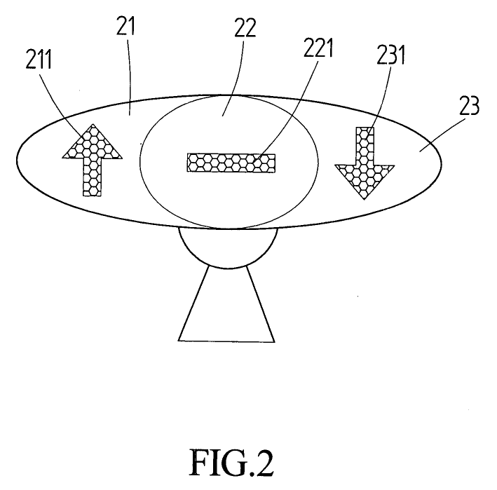

Referring to FIG. 2, the indication device of the present invention is installed to an obvious position of a vehicle and is electrically connected to a controller or a computer which detects the speed of the vehicle. In this embodiment, the indication device is installed at a rear end of a vehicle and includes a first section 21, a second section 22 and a third section 23. The first section 21 and the third section 23 are located on two ends of the second section 22.

An upward-arrow-shaped indication member 211 is located at the first section 21 and a downward-arrow-shaped indication member 231 is located at the third section 23. A horizontal-bar-shaped indication member 221 is installed at the second section 22.

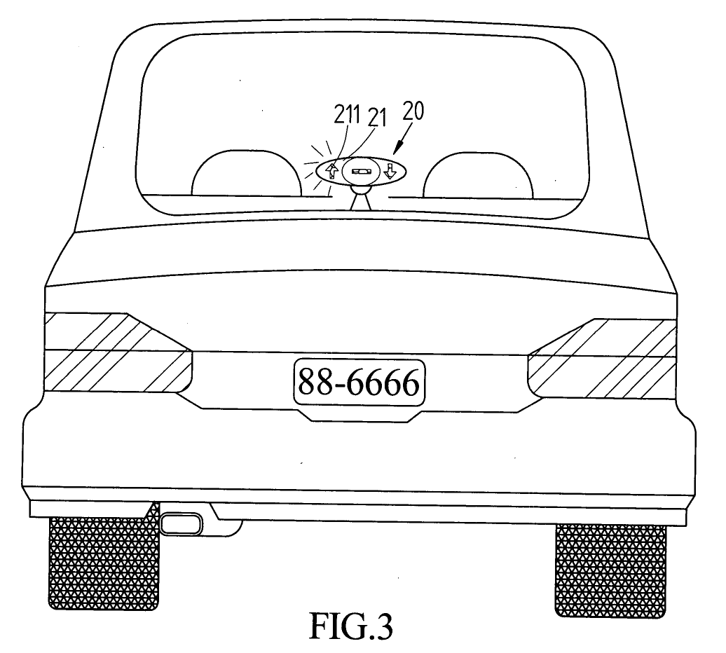

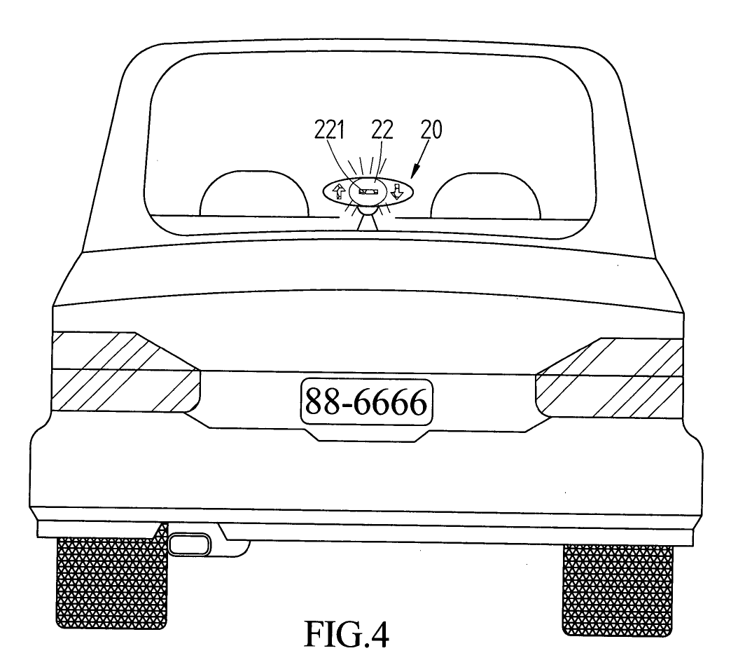

As shown in FIG. 3, when the vehicle accelerates, the upward-arrow-shaped indication member 211 in the first section 21 lights up, and when the vehicle's speed is below a pre-set value such as below 10 km/hr, the horizontal-bar-shaped indication member 221 of the second section 22 lights up as shown in FIG. 4. When the driver pushes the brake pedal, the downward-arrow-shaped indication member 231 of the third section 23 lights up.

By the indication device of the present invention, the drivers of the following vehicles can receive more detailed information of the vehicle in front of them and response accordingly to efficiently maintain a safety environment of driving. The indication members can be composed of any pattern and the way that the indication members are displayed can be used by any known method.

While we have shown and described the embodiment in accordance with the present invention, it should be clear to those skilled in the art that further embodiments may be made without departing from the scope of the present invention.

What is claimed is:

1. An indication device for vehicles, comprising:
a first section, a second section and a third section, the indication device being controlled by a controller, each section having an indication member which lights up to represent specific information of speed.

2. The device as claimed in claim 1, wherein the indication member of the first section indicates that the speed increases.

3. The device as claimed in claim 1, wherein the indication member of the second section indicates that the speed is below a pre-set value.

4. The device as claimed in claim 1, wherein the indication member of the third section indicates the speed reduces.
